(19) United States
(12) Patent Application Publication
(10) Pub. No.: US 2004/0124178 A1
(43) Pub. Date: Jul. 1, 2004

(54) Method for opening the contact gap of a vacuum interrupter

(76) Inventors: Joerg Kusserow, Neuenhagen (DE); Roman Renz, Berlin (DE)

Correspondence Address: MORRISON & FOERSTER LLP, 1650 TYSONS BOULEVARD, SUITE 300, MCLEAN, VA, 22102, US

(21) Appl. No.: 10/311,960

(22) PCT Filed: Jun. 6, 2001
(86) PCT No.: PCT/DE01/02126

(30) Foreign Application Priority Data
Jun. 20, 2000 (DE) 10030187.8

(51) Int. Cl. H01H 33/66; H01H 11/00

(52) U.S. Cl. 218/118; 29/622

(57) ABSTRACT

The aim of the invention is to improve the breaking ability of vacuum interrupter in the medium- and high-voltage range. Said aim is achieved whereby the contact pieces which may be displaced relative to each other are moved with a relatively high speed during a first phase (S1) of the separation process until about ¼ to ½ of the ultimate separation (extinction stroke Eh) and are brought to the given ultimate separation (isolating stroke Eh during a second phase (S2) with relatively low speed.

The invention relates to the field of electrical switches, and is applicable to the operation of vacuum interrupters which have two switching contact pieces which can move relative to one another and in which the disconnection capacity is intended to be improved by influencing the time sequence of the opening of the contact gap.

In electrical switches which contain a vacuum interrupter as the actual switching element, a drive linkage is provided for moving the switching contact piece which can be moved and is electrically connected to the exterior via a current supply bolt, which drive linkage acts on the moveable switching contact piece via a contact compression spring during the connection process and, during disconnection - after traveling through a certain acceleration distance - drives the moving switching contact piece suddenly. In order to stabilize the intrinsic high disconnection rating of such vacuum interrupters or such vacuum interrupters which are provided with radial field or axial field contact pieces, it is known for the moveable switching contact piece to be influenced directly after contact disconnection such that the contact gap is opened by at least 1 mm after at the latest 1.3 ms, that is to say for the moveable switching contact piece to be given a high initial acceleration. In the case of radial field contact pieces, it has been found to be advantageous for a contact piece disconnection speed of 2 m/s to be achieved after 0.8 ms.

With this known influence on the time sequence of the opening of the contact gap, the disconnection speed of the moveable switching contact piece is essentially constant over the entire contact travel, apart from the phase of the high initial acceleration and the severe braking on reaching the full contact travel (DE 38 15 805 C2).

Furthermore, a high-voltage vacuum switch is known, in which the contact travel is subdivided by means of a special design configuration of the vacuum interrupter into three sections which are referred to as “functional stages” (the switching travel, a first stage of the isolating travel and a second stage of the isolating travel). The special design configuration comprises the association of in each case one potential ring with each contact piece and an axially moveable arrangement of the housing of the vacuum interrupter with respect to the stationary switching contact piece. These measures mean that the two switching contact pieces are located in the field shadow of the respective potential ring when the moving switching contact is in the off position, thus improving the isolation capability of the vacuum interrupter for a given contact separation (DE 195 19 078 A1).

Against the background of a method for opening the contact gap in a vacuum interrupter which is designed for an operating voltage of at least 12 kV and which has two switching contact pieces in a housing, which can be moved relative to one another and are electrically connected to the exterior via current supply bolts (DE 38 15 805 C2), the invention is based on the object of further improving the disconnection capacity by specific action on the time sequence of the disconnection characteristic.

In order to achieve this object, the invention provides that in a first phase of the disconnection movement which is used for current quenching, the contact pieces are moved at a first speed to a contact separation of about 1/4 to 1/2 of a predetermined final separation, and that in a second phase of the disconnection movement which is used for voltage isolation, the contact pieces are moved at a second speed to a predetermined final separation, with the first speed being greater than the second speed. The first speed is expediently at least three times the second speed.

With a procedure such as this, the disconnection process is subdivided by means of time sequencing of a first section with a high switching speed and a second section with a slow switching speed into the functions of “current quenching/quenching travel” and “voltage isolation/isolating travel”, in which case the quenching travel should be chosen such that the switching arc is reliably quenched with a time of 2 to 15 ms at the next current zero crossing. The contact gap is then opened to the switching contact piece separation that is required dielectrically. —This procedure is based on the knowledge that, firstly, the disconnection capacity rises as the disconnection speed increases and that secondly —especially in the case of radial field but also in the case of axial field contacts —the disconnection capacity becomes greater the shorter the switching travel (quenching travel?); in this case, a lower limit is set for the switching travel by the required dielectric strength of the contact gap. —The invention also takes account of the knowledge that, during a switching process, the dielectric recovery of the conventional contact materials, in particular of CuCr, that is to say the time to return to the dielectric strength provided in the cold state, takes place within a few microseconds during the switching process, in which case, for medium-voltage vacuum interrupters (<36 kV), these dielectric strengths above the maximum return voltages (>60 kV) are reached just by a contact travel of 2 mm (after the current zero crossing). The dielectric recovery of the contact gap after the current zero crossing thus takes place considerably more quickly than the rise in the returning voltage. In consequence, the dielectric strength during the quenching travel is always greater than the transient return voltage associated with the respective voltage level. —The matching of the dielectric field strength of the contact gap to the mains condition, in particular to the lightning surge withstand voltage, then takes place at a greatly reduced speed, by further increasing the contact travel.

The splitting of the switching process in time into a quenching travel and an isolating travel with a different rate of travel and, in general, also with a different travel length needs to be chosen differently for vacuum interrupters in the medium—voltage range and in the high-voltage range (</>56 kV). For vacuum interrupters which are provided with radial field contacts or with magnetic field contacts and are designed for an operating voltage of 12 to 36 kV, it has been found to be expedient to use. a design on the basis of which the first speed is about 0.5 to 2 m/s and the second speed is about 0.1 to 0.3 m/s. In this case, the quenching travel is about 3 to 5 mm, and the total contact travel is about 8 to 20 mm.

For vacuum interrupters which are fitted with axial magnetic field contacts and are designed for an operating voltage of more than 52 kV, for example 72 kV, it has been found to use dimensions on the basis of which the first speed is about 1 to 3 m/s and the second speed is about 0.1 to 0.3 m/s. In this case, the quenching travel is about 20 mm, and the total contact travel is about 40 to 60 mm.

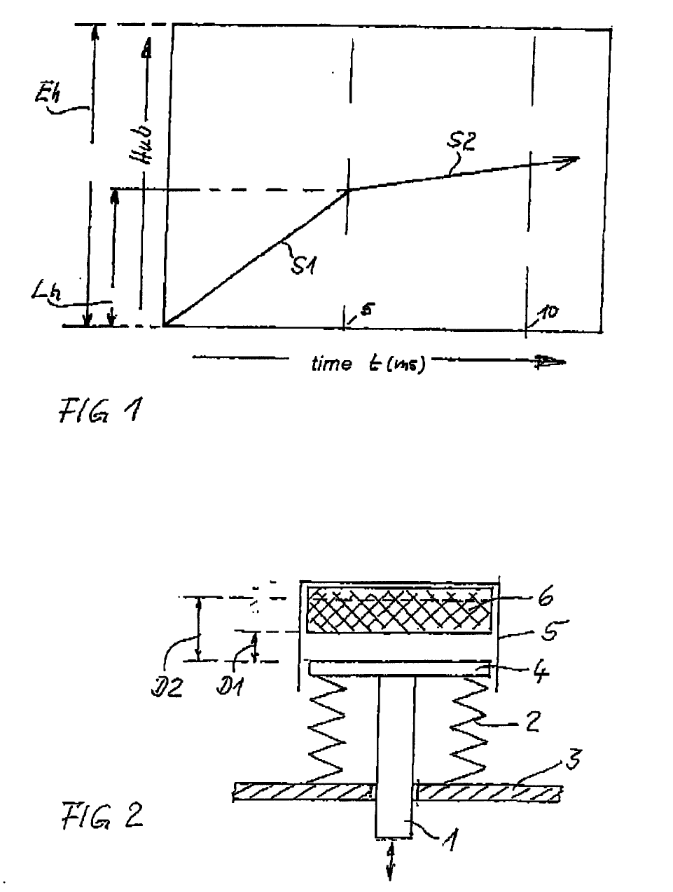

The two speeds during the opening of the contact gap can be achieved in various ways. By way of example, damping elements can be inserted into previously normal drive mechanisms. FIG. 2 shows one example of this. However, the drive can also be designed by means of appropriate cam disks such that the moveable switching contact is positively controlled by means of one cam disk. Such control is disclosed in principle in FIGS. 1 and 2 of DE 27 02 962 A1. —One particularly expedient possible way to produce the two speeds, according to a further refinement to the invention, is for the two switching contact pieces to be moved in opposite senses, with the first switching contact piece being moved at the first speed only during the first phase of the disconnection movement, and with the other switching contact piece being moved at the second speed only during the second phase of the disconnection movement, or else during both the first and the second phases of the disconnection movement. In the case of medium-voltage vacuum interrupters, the contact piece which is moved faster therefore needs to move only through a travel of 2 to 5 mm, while the contact piece which moves more slowly moves only through the further travel of about 6 to 15 mm, or through the total travel of 8 to 20 mm. In the case of vacuum interrupters for high-voltage purposes, the contact piece which moves more quickly moves only through the quenching travel of about 10 to 20 mm, and the contact piece which moves more slowly has to move through the further travel of 20 to 40 mm, so that the total travel is 40 to 60 mm. —US 4,901,251 A1 discloses a vacuum interrupter having two contact pieces which can be moved in opposite senses.

In order to explain the new method, FIG. 1 shows a diagram which illustrates the switching travel plotted against time.

The contact gap is opened in two sections S1, S2, which are shown as straight lines with different gradients. The straight line S1 indicates that the quenching travel Lh is reached after a time T1 which, by way of example, is 5 ms when the disconnection speed of the contact pieces is 1 m/s and the quenching travel is 5 mm. —The straight line S2 indicates that the final travel Eh is reached after a time t1 plus t2 which, by way of example is about 100 ms for a disconnection speed of 0.2 m/s and a final travel of 20 mm.

According to FIG. 2, a drive rod 1, which is coupled in a manner that is not illustrated in any more detail to the moveable contact piece of a vacuum interrupter, has an associated disconnection spring 2 which —supported on a board 3 —acts via a plate 4 on the drive rod 1. The plate 4 is at the same time part of a damping arrangement, which also includes a pot 5 and a damping element 6 arranged in the pot. During a disconnection movement, the plate 3 first of all moves without any impediment into the pot 4 until it teaches a depth D1 which corresponds to the quenching travel of the associated vacuum interrupter. There, the plate 4 meets a compressible damping element 6 as a result of which the speed at which the plate 4 continues to enter the pot 5 is correspondingly reduced until it reaches the position D2, which corresponds to the final travel of the vacuum interrupter.

1. A method for opening the contact gap in a vacuum interrupter, which is designed for an operating voltage of at least 12 kV and which has two switching contact pieces in a housing, which switching contact pieces can move relative to one another and are electrically connected to the exterior via current supply bolts, in which, in a first phase (S1) of the disconnection movement which is used for current quenching, the contact pieces are moved at a first speed to a contact separation (Lh) of about 1/4 to 1/2 of a predetermined final separation, and in which, in a second phase (S2) of the disconnection movement which is used for voltage isolation, the contact pieces are moved at a second speed to a predetermined final separation (Eh), with the first speed being greater. than the second speed.

2. The method as claimed in claim 1, characterized in that the first speed is at least three times the second speed.

3. The method as claimed in claim 2 for vacuum interrupters which are provided with radial field contacts and are designed for an operating voltage of 12 to 36 kV, characterized in that the first speed is about 0.5 to 2 m/s, and the second speed is about 0.1 to 0.3 m/s.

4. The method as claimed in claim 2 for vacuum interrupters which are fitted with axial magnetic field contacts and are designed for an operating voltage of more than 52 kV, characterized in that the first speed is about 1 to 3 m/s and the second speed is about 0.1 to 0.3 m/s.

5. The method as claimed in one of claims 1 to 4, characterized in that the disconnection movement is carried out by moving one of the two switching contact pieces, with damping forces (5) acting on the drive system for the movement of the switching contact piece in order to produce the second phase of the disconnection movement.

6. The method as claimed in claim 4, characterized in that the two switching contact pieces are moved in opposite senses, with the first switching contact piece being moved at the first speed only during the first phase of the disconnection movement, and the other switching contact piece being moved at the second speed, during the first and the second phase of the disconnection movement.
